(19) United States
(12) Patent Application Publication
(10) Pub. No.: US 2014/0266067 A1
(43) Pub. Date: Sep. 18, 2014

(54) Electrical Extension

(71) Applicant: Zvi Kurtzman, Sandy Springs, GA (US)

(72) Inventor: Zvi Kurtzman, Sandy Springs, GA (US)

(21) Appl. No.: 13/840,089

(22) Filed: Mar. 15, 2013

(51) Int. Cl. H02J 7/00

(52) U.S. Cl. CPC H02J 7/0052
USPC 320/139; 320/137; 320/149; 320/155

(57) ABSTRACT

An apparatus and method for configuring an electrical extension device, including measuring an electric current level being drawn from at least one of a plurality of electrical plugs by at least one of a plurality of loads; comparing the electric current level with a threshold to derive a comparison; and determining whether or not to charge the at least one of the plurality of loads based on the comparison. Additionally, the apparatus and method is for charging each of the at least one of the plurality of loads, wherein the charging is associated with a time duration, determining a charging state of one of the at least one of the plurality of loads and/or terminating the charge to the one of the at least one of the plurality of loads if the charging state indicates that it is at a fully charged capacity.

### FIELD

This disclosure relates generally to apparatus and methods for electrical extension devices. More particularly, the disclosure relates to electrical extension devices that allow charging variations.

### BACKGROUND

Currently, electronic devices are everywhere. Electronic devices can be found in the home, in the workplace, in businesses, in amusement parks. In some cases, gasoline or diesel engine powered vehicles (e.g., commercial trucks) carry loads that are electronic devices and require electrical charging. Because of the vast demands (in some cases because of the quantity of electrical devices needing charging, or in other cases, because of the high individual electric current demand of the electrical devices), electrical extension devices may short, blow a fuse or simply not be capable of catering to the vast demands of the various electronic devices at the same time. Thus, it would be desirable for an electrical extension device to be able to accommodate its electric current demand beyond its rated capacity.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

Disclosed is an apparatus and method for electrical extension. According to one aspect, a method for configuring an electrical extension device, including measuring an electric current level being drawn from at least one of a plurality of electrical plugs by at least one of a plurality of loads; comparing the electric current level with a threshold to derive a comparison; and determining whether or not to pulse charge the at least one of the plurality of loads based on the comparison. Additionally, the method may include pulse charging each of the at least one of the plurality of loads, wherein the pulse charging is associated with a time duration, determining a charging state of one of the at least one of the plurality of loads and/or terminating the pulse charge to the one of the at least one of the plurality of loads if the charging state indicates that it is at a fully charged capacity.

According to another aspect, a method for configuring an electrical extension device, including measuring an electric current level being drawn from a plurality of electrical plugs by a plurality of loads; comparing the electric current level with a threshold to derive a comparison; and determining whether or not to pulse charge the plurality of loads based on the comparison. Additionally, the method may include pulse charging each of the plurality of loads, wherein the pulse charging is associated with a time duration, determining a charging state of one of the plurality of loads and/or terminating the pulse charge to the one of the plurality of loads if the charging state indicates that it is at a fully charged capacity.

According to another aspect, an electrical extension device including a plurality of electrical plugs; a processor coupled to the plurality of electrical plugs for performing the following: a) measuring an electric current level being drawn from at least one of the plurality of electrical plugs by at least one of a plurality of loads; b) comparing the electric current level with a threshold to derive a comparison; and c) determining whether or not to pulse charge the at least one of the plurality of loads based on the comparison. In one example, the processor is further configured for pulse charging each of the at least one of the plurality of loads and the pulse charging is associated with a time duration, and the electrical extension device further includes a timing switch for implementing the time duration. In one example the electrical extension device further includes a charge detector for determining a charging state of one of the at least one of the plurality of loads, and the processor is further configured for terminating the pulse charging to the one of the at least one of the plurality of loads if the charging state indicates that it is at a fully charged capacity.

Advantages of the present disclosure may include accommodating electrical loads beyond an electrical extension's rated maximum electric current, reducing the need to charge electrical devices in a sequential fashion, reducing the need for additional electrical extension devices and thus reducing cost in buying additional electrical extension devices.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 illustrates an example of an electrical extension device.

FIG. 2 illustrates an example of a first flow diagram for configuring an electrical extension device.

FIG. 3 illustrates an example of a second flow diagram for configuring an electrical extension device.

FIG. 4 illustrates an example of a device including a processor in communication with a memory for configuring an electrical extension device.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the present disclosure.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

FIG. 1 illustrates an example of an electrical extension device 100. In one example, the electrical extension device 100 includes a processor 110, a processor input 105, N quantity of control channels 115 and N quantity of electrical plugs 130 to service up to N quantity of loads 180. An energy source 190 for the electrical extension device 100 is also shown in FIG. 1. In one example, the processor input 105 allows manual configuration of the processor by a user. In another example, the processor input 105 takes input of software and/or firmware programming for the processor 110.

In one example, the electrical extension device 100 includes a plurality of switches 116 (not shown) and/or relay mechanisms 117 (not shown) which are coupled to the processor 110 and which are also coupled to the electrical plugs 130. One skilled in the art would understand that switches may be used separately, relay mechanisms may be used separately or a combination of switches and relay mechanisms may be used to accommodate the plurality of electrical plugs 130. In one example, each electrical plug 130 is associated with either a switch 116 or a relay mechanism 117.

In one example, when engaged by the processor 110, the switches 116 and/or relay mechanisms 117 enable the electrical plugs 130. In another example, when disengaged by the processor 110, the switches 116 and/or relay mechanisms 117 disenable the electrical plugs 130. In one example, each electrical plug 130 may be enabled or disabled separately from the other electrical plugs 130 by the processor 110. Or, a grouping of electrical plugs 130 may be enabled or disabled together.

One skilled in the art would understand that the switches and relay mechanisms are not confined to a mechanical type and may be of an electrical type or other types not mentioned herein but known to one skilled in the art.

In one example, the electrical extension device 100 is rated for a maximum electric current (in amperes) per time unit when being used in full capacity. The load 180 is any electrical device or electrical component that is coupled to the electrical plugs 130 to receive an energy recharge (e.g., electric current recharge or voltage recharge).

In one example, the electrical extension device 100 includes a timing switch 150 (not shown) that is coupled to the processor 110 and one or more of the electrical plugs 130. In one example, the processor 110 measures the electric current level being drawn by each of the loads 180 through their respective electrical plugs 130. In one example, total electric current level being drawn by all the loads 180 is determined. The processor compares the electric current level being drawn by each of the loads 180 with a first threshold to derive a first comparison. In one example, the processor 110 compares the total electric current level being drawn by all the loads 180 and compares the total electric current level to a second threshold to derive a second comparison. One skilled in the art would understand that the method of comparing the electric current level drawn by each of the load and the method of comparing the total electric current level drawn may be used separately or in conjunction with each other.

In one example, the first comparison and/or the second comparison are used by the processor 110 to determine whether to initiate pulse charging of the electrical plugs 130. In one example, pulse charging of the electrical plugs may be set as a default condition in which the electrical plugs coupled to a load are always pulsed charged sequentially to each other without having to be initiated by the processor 110. Although pulse charging is described in the examples, regular (e.g., non-pulse) charging are equally applicable to the examples.

In one example, pulse charging the electrical plugs 130 is initiated when the electric current level being drawn by the loads 180 (i.e., the electric current level being drawn by a particular electrical plug 130 or the total electric current level being drawn from the electrical extension device 100) exceeds a predefined threshold. The pulse charging is achieved with the energy source 190.

In one example, the electrical plugs 130 are associated with a charge detector 160 (not shown). In one example, the charge detector 160 determines a charging state of a load. That is, the charge detector 160 determines how fully charged the load is at a particular given time. If the charge detector 160 determines that the load is at fully charged capacity, the processor can terminate charging of that load through the associated electrical plug 130.

FIG. 2 illustrates an example of a first flow diagram 200 for configuring an electrical extension device. In block 210, measure an electric current level being drawn from at least one of a plurality of electrical plugs by at least one of a plurality of loads. In block 220 compare the electric current level with a threshold to derive a comparison. In one example, the comparison is a binary indication to indicate whether the electric current level is greater than or equal to the threshold in one binary state, or whether the electric current level is less than the threshold in another binary state. In one example, the comparison is a quantitative value that indicates the difference and polarity (greater than or less than) between the electric current level and the threshold.

In block 230, determine whether or not to pulse charge the at least one of the plurality of loads based on the comparison. In block 240, pulse charge each of the at least one of the plurality of loads, wherein the pulse charge is associated with a time duration. In one example, each of the at least one of the plurality of loads is pulse charged for Q seconds. And, the pulse charging process continues through each of the at least one of the plurality of loads until the last load before repeating the pulse charging process with the first load. That is, load₁ is pulse charged for Q seconds, then load₂ is pulse charged for Q seconds, and so on until load_{N} is pulse charged for Q seconds before repeating the process by starting with load₁ again. In this example, the Q seconds is the time duration. In one example, the time duration of the pulse charge is implemented by the timing switch 150 in association with the processor 110.

In block 250, determine a charging state of one of the at least one of the plurality of loads. In block 260, terminate the pulse charge to the one of the at least one of the plurality of loads if the charging state indicates that it is at a fully charged capacity. One skilled in the art would understand that being at a fully charged capacity includes a tolerance and need not be exactly at the fully charged capacity state. Although pulse charging is described in the example of FIG. 2, regular (e.g., non-pulse) charging are equally applicable to all the steps described.

FIG. 3 illustrates an example of a second flow diagram for configuring an electrical extension device. In block 310, measure an electric current level being drawn from a plurality of electrical plugs by a plurality of loads. In one example, the electric current level is the total electric current level being drawn from the electrical extension device 100 by the plurality of loads at a particular point in time.

In block 320 compare the electric current level with a threshold to derive a comparison. In one example, the value of the threshold is equal to the maximum rated electric current (in amperes) per time unit of the electrical extension device 100.

In one example, the comparison is a binary indication to indicate whether the electric current level is greater than or equal to the threshold in one binary state, or whether the electric current level is less than the threshold in another binary state. In one example, the comparison is a quantitative value that indicates the difference and polarity (greater than or less than) between the electric current level and the threshold.

In block 330, determine whether or not to pulse charge the plurality of loads based on the comparison. In block 340, pulse charge the plurality of loads, wherein the pulse charge is associated with a time duration. In one example, the plurality of loads is pulse charged for Q seconds. And, the pulse charging process continues through each of the plurality of loads until the last load before repeating the pulse charging process with the first load. That is, load₁ is pulse charged for Q seconds, then load₂ is pulse charged for Q seconds, and so on until loads is pulse charged for Q seconds before repeating the process by starting with load₁ again. In this example, the Q seconds is the time duration. In one example, the time duration of the pulse charge is implemented by the timing switch 150 in association with the processor 110.

In block 350, determine a charging state of one of the plurality of loads. In block 360, terminate the pulse charge to the one of the plurality of loads if the charging state indicates that the one of the plurality of loads is at a fully charged capacity. One skilled in the art would understand that being at a fully charged capacity includes a tolerance and need not be exactly at the fully charged capacity state. Although pulse charging is described in the example of FIG. 3, regular (e.g., non-pulse) charging are equally applicable to all the steps described.

Although the examples are presented using electric current level drawn, one skilled in the art would understand that voltage requirements of the load may be used in place of electric current level drawn without affecting the scope and spirit of the present disclosure.

One skilled in the art would understand that the steps disclosed in the example flow diagrams in FIGS. 2 and 3 can be interchanged in their order without departing from the scope and spirit of the present disclosure. Also, one skilled in the art would understand that the steps illustrated in the flow diagram are not exclusive and other steps may be included or one or more of the steps in the example flow diagram may be deleted without affecting the scope and spirit of the present disclosure.

Those of skill would further appreciate that the various illustrative components, logical blocks, modules, circuits, and/or algorithm steps described in connection with the examples disclosed herein may be implemented as electronic hardware, firmware, computer software, or combinations thereof. To clearly illustrate this interchangeability of hardware, firmware and software, various illustrative components, blocks, modules, circuits, and/or algorithm steps have been described above generally in terms of their functionality. Whether such functionality is implemented as hardware, firmware or software depends upon the particular application and design constraints imposed on the overall system. Skilled artisans may implement the described functionality in varying ways for each particular application, but such implementation decisions should not be interpreted as causing a departure from the scope or spirit of the present disclosure.

For example, for a hardware implementation, the processing units (a.k.a. processor) may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described therein, or a combination thereof. With software, the implementation may be through modules (e.g., procedures, functions, etc.) that perform the functions described therein. The software codes may be stored in memory units and executed by a processor unit. Additionally, the various illustrative flow diagrams, logical blocks, modules and/or algorithm steps described herein may also be coded as computer-readable instructions carried on any computer-readable medium known in the art or implemented in any computer program product known in the art. In one aspect, the computer-readable medium includes non-transitory computer-readable medium.

In one or more examples, the steps or functions described herein may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair. DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In one example, the illustrative components, flow diagrams, logical blocks, modules and/or algorithm steps described herein are implemented or performed with one or more processors. In one aspect, a processor is coupled with a memory which stores data, metadata, program instructions, etc. to be executed by the processor for implementing or performing the various flow diagrams, logical blocks and/or modules described herein. FIG. 4 illustrates an example of a device 400 including a processor 410 in communication with a memory 420 for configuring an electrical extension device. In one example, the device 400 is used to implement the algorithm illustrated in FIGS. 2 and 3. In one aspect, the memory 420 is located within the processor 410. In another aspect, the memory 420 is external to the processor 410. In one aspect, the processor includes circuitry for implementing or performing the various flow diagrams, logical blocks and/or modules described herein.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

1. A method for configuring an electrical extension device, comprising:
measuring an electric current level being drawn from at least one of a plurality of electrical plugs by at least one of a plurality of loads;
comparing the electric current level with a threshold to derive a comparison; and
determining whether or not to charge the at least one of the plurality of loads based on the comparison.

2. The method of claim 1, further comprising charging each of the at least one of the plurality of loads, wherein the charging is associated with a time duration.

3. The method of claim 2, further comprising determining a charging state of one of the at least one of the plurality of loads.

4. The method of claim 3, further comprising terminating the charge to the one of the at least one of the plurality of loads if the charging state indicates that it is at a fully charged capacity.

5. The method of claim 4, wherein the comparison is a first binary indication to indicate whether the electric current level is greater than or equal to the threshold in one binary state and whether the electric current level is less than the threshold in a second binary state.

6. The method of claim 4, wherein the comparison is a quantitative value that indicates the difference and polarity between the electric current level and the threshold.

7. The method of claim 2, wherein the charging is pulse charging.

8. The method of claim 2, wherein the charging is regular (non-pulse) charging.

9. A method for configuring an electrical extension device, comprising:
measuring an electric current level being drawn from a plurality of electrical plugs by a plurality of loads;
comparing the electric current level with a threshold to derive a comparison; and
determining whether or not to charge the plurality of loads based on the comparison.

10. The method of claim 9, further comprising charging each of the plurality of loads, wherein the charging is associated with a time duration.

11. The method of claim 10, further comprising determining a charging state of one of the plurality of loads.

12. The method of claim 11, further comprising terminating the charge to the one of the plurality of loads if the charging state indicates that it is at a fully charged capacity.

13. The method of claim 12, wherein the comparison is a first binary indication to indicate whether the electric current level is greater than or equal to the threshold in one binary state and whether the electric current level is less than the threshold in a second binary state.

14. The method of claim 12, wherein the comparison is a quantitative value that indicates the difference and polarity between the electric current level and the threshold.

15. The method of claim 10, wherein the charging is pulse charging.

16. The method of claim 10, wherein the charging is regular (non-pulse) charging.

17. An electrical extension device comprising:
a plurality of electrical plugs;
a processor coupled to the plurality of electrical plugs for performing the following:
a) measuring an electric current level being drawn from at least one of the plurality of electrical plugs by at least one of a plurality of loads;
b) comparing the electric current level with a threshold to derive a comparison; and
c) determining whether or not to charge the at least one of the plurality of loads based on the comparison.

18. The electrical extension device of claim 17, wherein the processor is further configured for charging each of the at least one of the plurality of loads and the charging is associated with a time duration, and further comprising a timing switch for implementing the time duration.

19. The electrical extension device of claim 18, further comprising a charge detector for determining a charging state of one of the at least one of the plurality of loads.

20. The electrical extension device of claim 19, wherein the processor is further configured for terminating the charging to the one of the at least one of the plurality of loads if the charging state indicates that it is at a fully charged capacity.

21. The electrical extension device of claim 20, wherein the comparison is a first binary indication to indicate whether the electric current level is greater than or equal to the threshold in one binary state and whether the electric current level is less than the threshold in a second binary state.

22. The electrical extension device of claim 20, wherein the comparison is a quantitative value that indicates the difference and polarity between the electric current level and the threshold.

23. The electrical extension device of claim 18, wherein the charging is pulse charging.

24. The electrical extension device of claim 18, wherein the charging is regular (non-pulse) charging.
